(19) United States
(12) Patent Application Publication
(10) Pub. No.: US 2025/0347535 A1
(43) Pub. Date: Nov. 13, 2025

(54) POSITIONAL DETECTION DEVICE WITH MAGNETIC SENSING TECHNOLOGY

(71) Applicant: C&K COMPONENTS S.A.S., Dole (FR)

(72) Inventors: Birame Ndiaye, Milford, MA (US); Frank Domzalski, Wellesley, MA (US); Andrew Lamoreaux, East Greenwich, RI (US); Adam Lagro, Chemlsford, MA (US)

(73) Assignee: C&K COMPONENTS S.A.S., Dole (FR)

(21) Appl. No.: 18/660,955

(22) Filed: May 10, 2024

(51) Int. Cl. G01D 5/16

(52) U.S. Cl. CPC G01D 5/16

(57) ABSTRACT

A positional detection device that includes magnetic sensing technology is provided. The positional detection device can include a housing, a switching device, such as a tunnel magnetoresistance (TMR) integrated circuit (IC) or a reed switch, inside of the housing, and a magnet coupled to an actuator. Activation of the actuator can move the magnet and cause a magnetic field, such as the magnetic field to which the switching device is exposed, to change, and responsive to the change in the magnetic field, the switching device can allow current flow therethrough. The positional detection device can also include one or more resistors coupled to the switching device that can determine the current flow responsive to the switching device being activated and deactivated.

### FIELD

The present disclosure generally relates to positional detection devices. More particularly, the present disclosure relates to a positional detection device that incorporates magnetic sensing technology.

### BACKGROUND

Known positional detection devices include a mechanical snap switch or a tactile switch to activate the positional detection device. However, these components wear out over time.

In view of the above, there is a continuing, ongoing need for a positional detection device with long-life components that withstand usage over time. Preferably, such components are small enough to fit within a form factor of known positional detection devices and include error-detection technology for diagnostic functions.

### BRIEF SUMMARY

This Brief Summary is provided to introduce a selection of concepts in a simplified form that are further described below in the Detailed Description. This Brief Summary is not intended to identify key features or essential features of claimed subject matter or intended as an aid in determining scope of the claimed subject matter.

In some embodiments, a positional detection device can include a housing, a tunnel magnetoresistance (TMR) integrated circuit (IC) on a printed circuit board (PCB) inside of the housing, a pair of magnets disposed on an actuator inside of the housing, and an activation mechanism disposed outside of the housing and coupled to the actuator. Activation of the activation mechanism can cause the actuator to actuate, the pair of magnets to move towards the TMR IC, and a magnetic field around the TMR IC to change, and responsive to the change in the magnetic field, the TMR IC can allow current flow therethrough.

In some embodiments, the activation mechanism can include a rubber dome that can provide a spring force and haptics.

In some embodiments, the TMR IC can be centered between the pair of magnets.

In some embodiments, each of the pair of magnets can face the TMR IC.

In some embodiments, a respective south pole of each of the pair of magnets can face the TMR IC.

In some embodiments, the actuator can include a leaf-style lever.

In some embodiments, the actuator can include a wishbone-style lever.

In some embodiments, the positional detection device can include at least one resistor on the PCB that can enable diagnostic functions.

In some embodiments, a positional detection device can include a housing, a TMR IC on a PCB inside of the housing, a magnet disposed on an actuator, a first resistor coupled to the TMR IC on the PCB, and a second resistor coupled to the TMR IC on the PCB. Activation of the actuator can cause the magnet to move towards the TMR IC and a magnetic field around the TMR IC to change, and responsive to the change in the magnetic field, a voltage output of the TMR IC can changes from high to low. When the voltage output of the TMR IC is high, no current can flow through the TMR IC or the first resistor. When the voltage output of the TMR IC is low, the current can flow through the TMR IC and the first resistor.

In some embodiments, the first resistor can be connected to the TMR IC in series.

In some embodiments, the second resistor can be connected to the TMR IC in parallel.

In some embodiments, the voltage output of the TMR IC can be high when the actuator is released.

In some embodiments, when the voltage output of the TMR IC is high, the current can flow through the second resistor.

In some embodiments the voltage output of the TMR IC can be low when the actuator is activated.

In some embodiments, when the voltage output of the TMR IC is low, the current can flow through the first resistor and the second resistor.

In some embodiments, the TMR IC, the first resistor, and the second resistor can form a circuit, the circuit can be connected to an external system via a pull up resistor, and voltage output to the customer system can be a full supply voltage when a wire between the circuit and the pull up resistor is broken.

In some embodiments, the TMR IC, the first resistor, and the second resistor can form a circuit, the circuit can be connected to an external system via a pull up resistor, and voltage output to the customer system can be 0 when a wire between the circuit and the pull up resistor is shorted.

In some embodiments, a positional detection device can include a housing, a switching device inside of the housing, and a magnet coupled to an actuator. Activation of the actuator can cause a magnetic field to change, and responsive to the change in the magnetic field, the switching device can allow current flow therethrough.

In some embodiments, the actuator can include a lever disposed outside of the housing.

In some embodiments, the positional detection device can at least one resistor on the PCB that can enables diagnostic functions.

Other technical features may be readily apparent to one skilled in the art from the following figures, descriptions, and claims.

### BRIEF DESCRIPTION OF THE SEVERAL VIEWS OF THE DRAWINGS

FIG. 1 is an exploded view illustrating a positional detection device in accordance with disclosed embodiments.

FIG. 2 is an internal view illustrating a positional detection device in accordance with disclosed embodiments.

FIG. 3 is an exploded view illustrating an actuator in accordance with disclosed embodiments.

FIG. 4 is a side view illustrating an actuator in accordance with disclosed embodiments.

FIG. 5 is a perspective view illustrating an actuator in accordance with disclosed embodiments.

FIG. 6 is a perspective view illustrating internal components of a positional detection device in accordance with disclosed embodiments.

FIG. 7 is a perspective view illustrating internal components of a positional detection device in accordance with disclosed embodiments.

FIG. 8 is a circuit diagram representing a positional detection system in accordance with disclosed embodiments.

FIG. 9A is a circuit diagram representing a positional detection system in accordance with disclosed embodiments.

FIG. 9B is a circuit diagram representing a positional detection system in accordance with disclosed embodiments.

FIG. 9C is a circuit diagram representing a positional detection system in accordance with disclosed embodiments.

FIG. 9D is a circuit diagram representing a positional detection system in accordance with disclosed embodiments.

FIG. 10 is an internal view illustrating a positional detection device in accordance with disclosed embodiments.

FIG. 11 is a perspective view illustrating a positional detection device in accordance with disclosed embodiments.

FIG. 12 is an internal view illustrating a positional detection device in accordance with disclosed embodiments.

FIG. 13 is a perspective view illustrating a positional detection device in accordance with disclosed embodiments.

FIG. 14A is a side view illustrating an actuator and a magnet in accordance with disclosed embodiments.

FIG. 14B is a side view illustrating a magnet and a reed switch in accordance with disclosed embodiments.

FIG. 14C is a side view illustrating a magnet and a reed switch in accordance with disclosed embodiments.

### DETAILED DESCRIPTION

Exemplary embodiments of a positional detection device in accordance with the present disclosure will now be described more fully hereinafter with reference made to the accompanying drawings. The positional detection device may, however, be embodied in many different forms and should not be construed as being limited to the embodiments set forth herein. Rather, these embodiments are provided so that this disclosure will convey certain exemplary aspects of the positional detection device to those skilled in the art.

In accordance with disclosed embodiments, a positional detection device can include magnetic sensing technology. As such, components of the positional detection device can withstand usage over time, thereby extending a life thereof. In some embodiments, the components of the positional detection device disclosed herein can be small enough to fit within a form factor of positional detection devices known in the art.

In some embodiments, the positional detection device can include a TMR switch. In particular, a tunnel magnetoresistance (TMR) integrated circuit (IC) can be disposed on a printed circuit board (PCB) and sealed inside of a housing. An actuator, such as a lever, can include a magnet disposed thereon, and when the actuator is depressed, such as by a target device, a position of which the positional detection device is measuring, the magnet can move towards the TMR IC, thereby changing a magnetic field around the TMR IC, which can change current flowing through the TMR IC.

Additionally or alternatively, in some embodiments, the positional detection device can include a reed switch. In particular, the reed switch can be disposed on the PCB and sealed inside of the housing. When the actuator is depressed, a position of the magnet relative to the reed switch can change, thereby activating the reed switch, which can change the current flowing through the reed switch. In some embodiments, the magnet can rotate relative to the reed switch to minimize required vertical travel of the actuator.

In some embodiments, the positional detection device disclosed herein can also include error-detection technology for diagnostic functions, including resistive diagnostic functions. For example, in come embodiments, the positional detection device can include one or more resistors on the PCB that can provide a first resistance, such as a specific low resistance, when a switch of the positional detection device is in a first state, such as closed, and a second resistance, such as a specific high resistance, when the switch is in a second state, such as open. In some embodiments, a broken wire connection can result in an open circuit.

In accordance with disclosed embodiments, the PCB can be assembled with all components thereon before insertion into the housing, thereby allowing for ease of manufacturing. Then, the housing can be sealed with epoxy to further protect the components thereof, including the switch, from moisture and other contaminants. In some embodiments, one or more wires can extend from the housing to carry an output signal of the positional detection device to an external system.

Advantageously, the positional detection device disclosed herein can eliminate moving contacts of known mechanical positional detection devices by eliminating physical interaction with switching elements. Indeed, TMR switches and reed switches can provide superior electrical life as compared to snap detect switches because actuators and magnets do not wear in the same manner as snap switches or tactile switches. Further, the positional detection device disclosed herein can increase overtravel while reducing differential travel of moving parts. Indeed, actuators and magnets can move, traverse, rotate, and/or slide relative to sensing components, and the sensing components can detect such movement between an activation position and a deactivation position without requiring the magnets having to travel long distances.

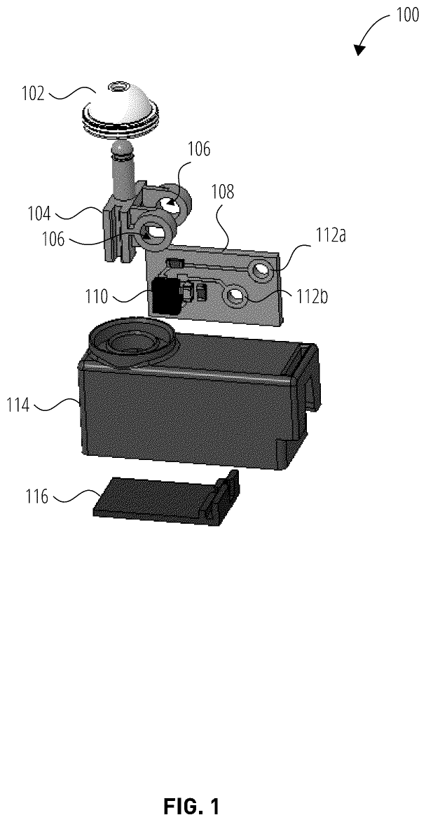

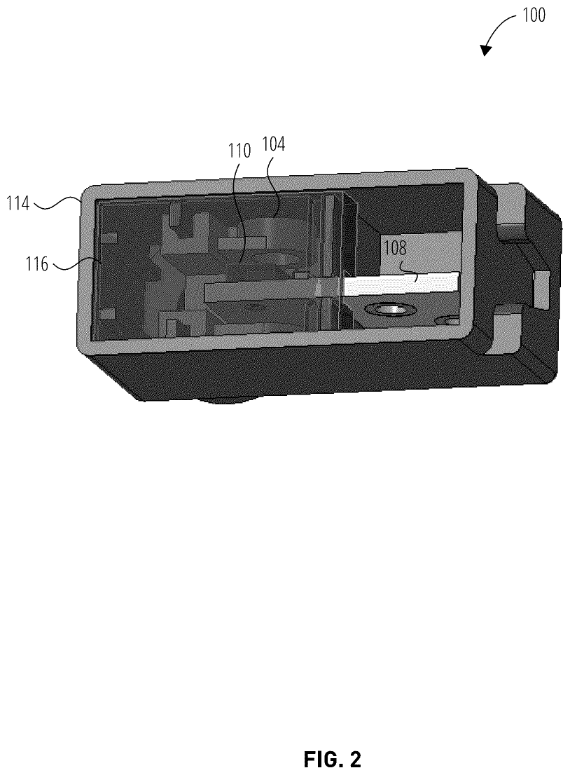

FIG. 1 is an exploded view illustrating a positional detection device 100 in accordance with disclosed embodiments, and FIG. 2 is an internal view illustrating the positional detection device 100. As seen, the positional detection device 100 can include a housing 114, a tunnel magnetoresistance (TMR) integrated circuit (IC), TMR IC 110, on a printed circuit board (PCB) 108 inside of the housing 114, a pair of magnets (not shown in FIG. 1 and FIG. 2) disposed in and held, supported, protected, and moved by magnet receptacles 106 on an actuator 104 inside of the housing 114, and an activation mechanism 102 disposed outside of the housing 114 and coupled to the actuator 104. For example, the actuator 104 can move vertically relative to the TMR IC 110 and the PCB 108 responsive to the activation mechanism 102. In some embodiments, the activation mechanism 102 can include a rubber dome, and in some embodiments, the activation mechanism 102 can provide a spring force and/or haptics.

The cover plate 116 can cover at least part of an open end of the housing 114 into which components of the positional detection device 110 can be inserted. For example, in some embodiments, the cover plate 116 can seal a first internal section of the housing 114 in which moving components of the positional detection device 100, including the actuator 104 and the magnets, are located. In these embodiments, non-moving components of the positional detection device 100, including copper traces 112a, 112b on the PCB 108, and wire leads for connecting thereto can be located in a second internal section of the housing 114. In some embodiments, epoxy can fill the second internal section of the housing 114, and in some embodiments, epoxy can seal the cover plate 116 to the housing 114.

The actuator 104 illustrated in FIG. 1 and FIG. 2 includes a leaf-style lever. However, embodiments disclosed herein are not so limited. Instead, the actuator 104 can include any type of actuator and/or lever that can move and support magnets as disclosed herein. For example, in some embodiments, the actuator 104 can include a wishbone-style lever.

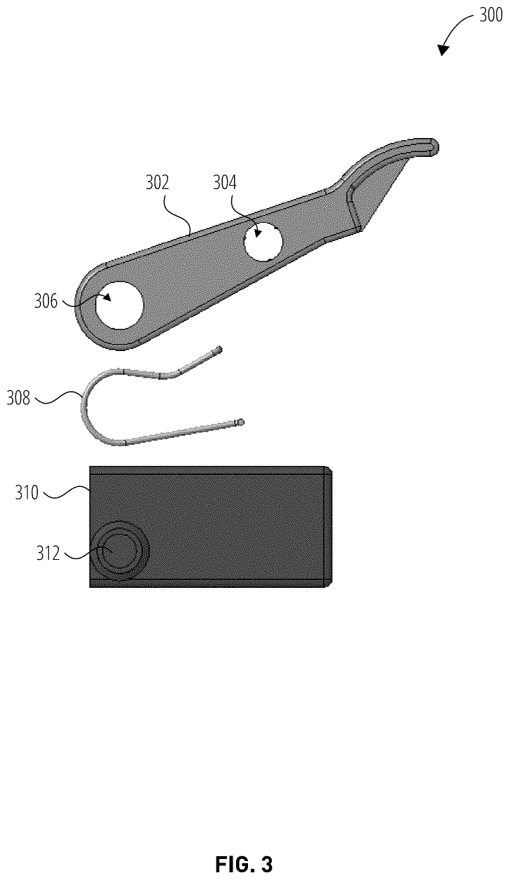

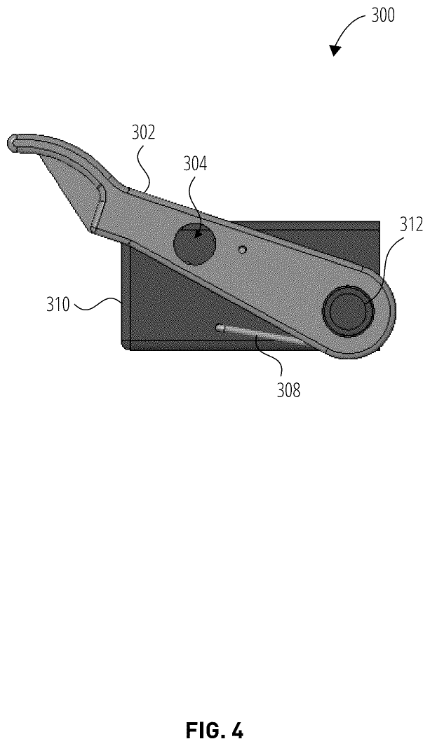

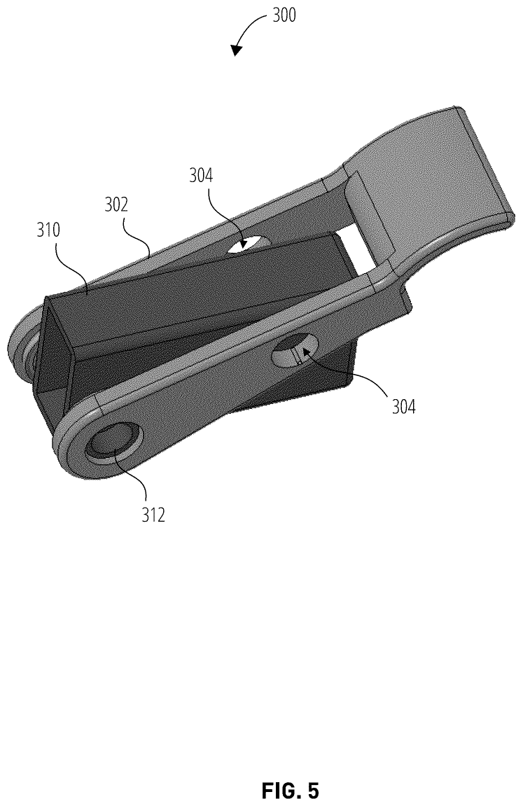

In this regard, FIG. 3 is an exploded view illustrating an actuator 300 in accordance with disclosed embodiments, FIG. 4 is a side view illustrating the actuator 300, and FIG. 5 is a perspective view illustrating the actuator 300. As seen, the actuator 300 can include a lever 302 with one or more magnet receptacles 304 therein for holding, supporting, protecting, and moving one or more magnets (not shown in FIG. 3, FIG. 4, and FIG. 5). The lever 302 can also include one or more attachment receptacles 306, which can be attached to a housing attachment 312 of a housing 310. In some embodiments, the housing 310 can be or be part of the housing 114. The lever 302 can move in a partially circumferential manner around the housing attachment 312, and in some embodiments, a lever force can be provided by a spring 308, for example, a torsion spring, thereby causing the lever 302 to snap over bosses in the housing 310, for example, the housing attachment 312.

Referring back to FIG. 1, when the activation mechanism is released, the actuator and the magnets can be in a deactivation position. However, responsive to the activation mechanism 102 being activated, the actuator 104 can actuate, that is, move, traverse, rotate, and/or slide, into an activation position, thereby moving the magnets towards the TMR IC 110 and into the activation position. When the magnets are in the activation position, a magnetic field around the TMR IC 110 can change, and responsive to the change in the magnetic field, the TMR IC 110 can allow current to flow therethrough.

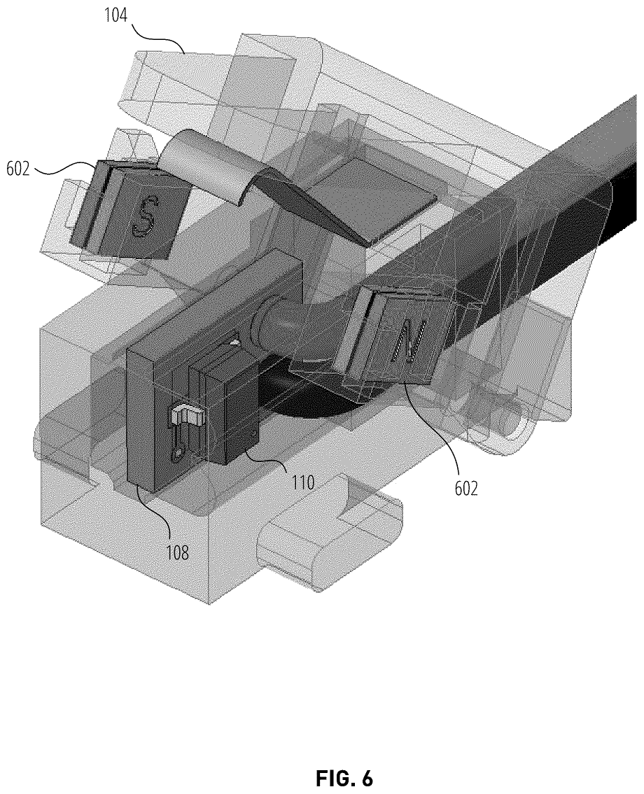

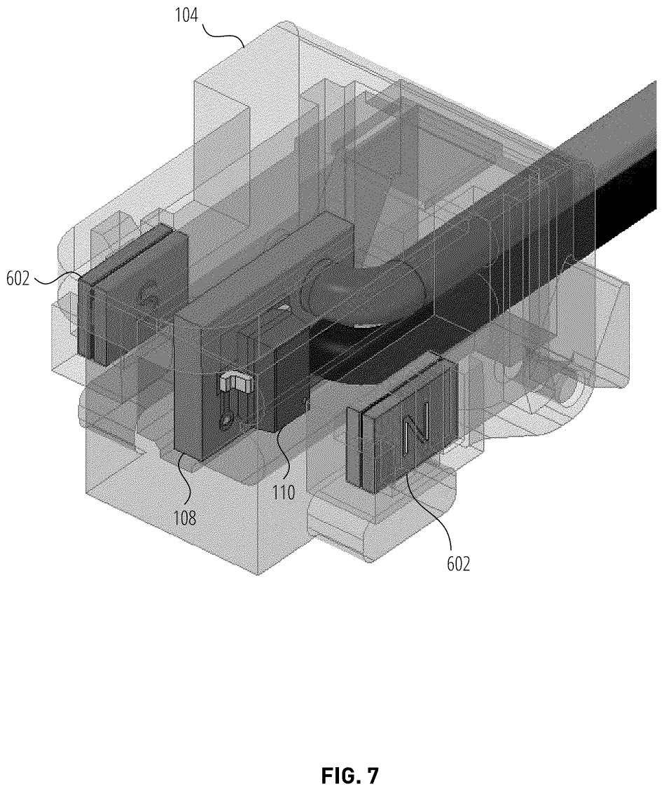

In this regard, FIG. 6 and FIG. 7 are perspective views illustrating internal components of the positional detection device 100 in accordance with disclosed embodiments. As seen, the actuator 104 can hold, support, protect, and move magnets 602. In some embodiments, the TMR IC 110 can be centered between the magnets 602, and in some embodiments, each of the magnets 602 can face the TMR IC 110, for example, when the magnets 602 are in the activation position. In particular, in FIG. 6 and FIG. 7, a respective south pole of each of the magnets 602 can face the TMR IC 110. However, embodiments disclosed are not so limited, and some embodiments can include a respective north pole of each of the magnets 602 facing the TMR IC 110.

In FIG. 6, the actuator 104 and the magnets 602 are in the deactivation position. However, in FIG. 7, the actuator 104 and the magnets 602 are in the activation position. That is, the actuator 104 and the magnets 602 are closer to the TMR IC 110 in the activation position of FIG. 7 than in the deactivation position of FIG. 6. As such, a magnetic field around the TMR IC 110 is different in FIG. 7 as compared to FIG. 6.

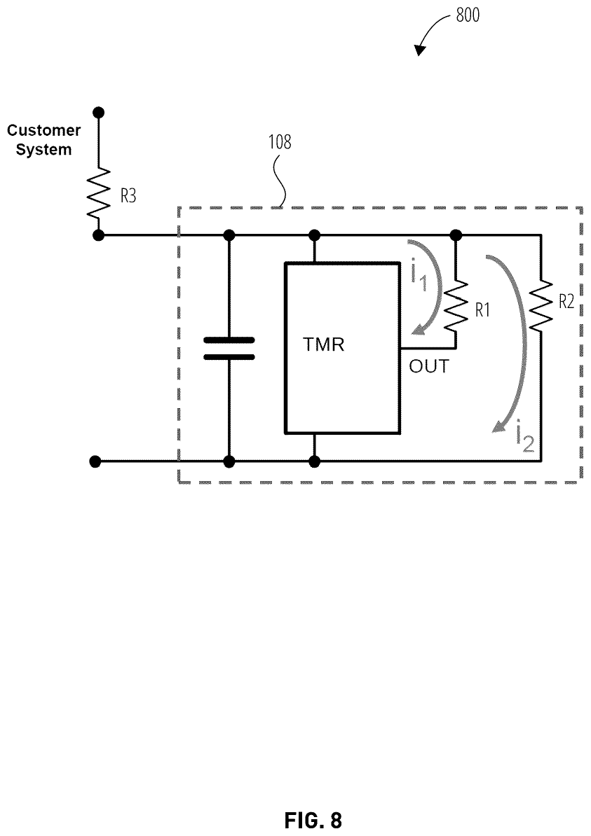

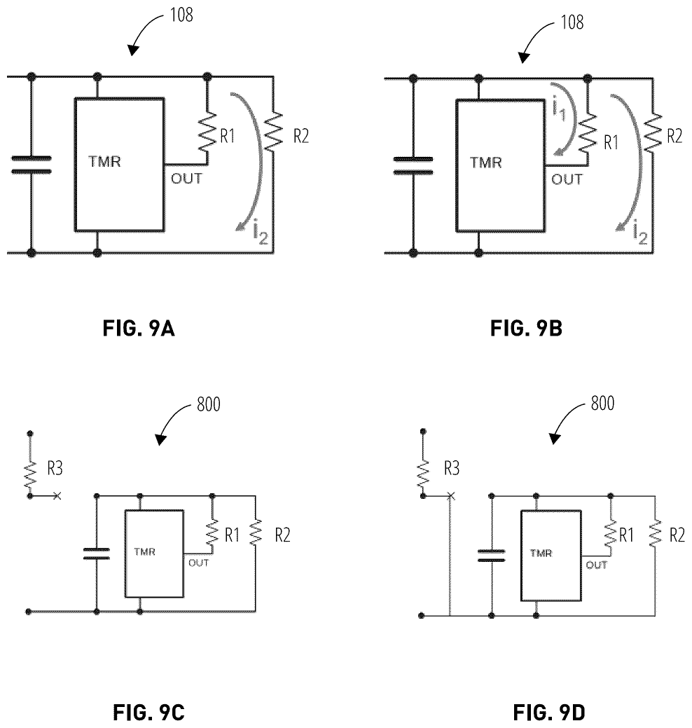

In some embodiments, at least one resistor can be included on the PCB that can enable diagnostic functions. In this regard, FIG. 8, FIG. 9A, FIG. 9B, FIG. 9C, and FIG. 9D are circuit diagrams of a circuit 800 disposed on and connected to a PCB, for example, the PCB 108, in accordance with disclosed embodiments.

As seen, a first resistor R1 can be coupled to the TMR IC 110 on the PCB 108, and a second resistor R2 can be coupled to the TMR IC 110 on the PCB 108. In some embodiments, the first resistor R1 can be connected to the TMR IC 110 in series. Additionally or alternatively, in some embodiments, the second resistor R2 can be connected to the TMR IC 110 in parallel.

As disclosed herein, when an actuator is activated, the actuator and magnets carried thereon can move towards the TMR IC 110, and when the magnets are moved towards the TMR IC 110, a magnetic field around the TMR IC 110 can change. Responsive to the change in the magnetic field, a voltage output of the TMR IC 110 can change. For example, in some embodiments, the voltage output can change from high to low, and in some embodiments, the voltage output can change from low to high. In any embodiment, a change in the voltage output of the TMR IC 110 can cause a change in current flow on the PCB.

In particular, and as illustrated in FIG. 9A, when the voltage output of the TMR IC 110 is at a first level, for example, high, no current flows through the TMR IC 110 or the first resistor R1. Instead, the current can flow through the second resistor R2. In these embodiments, the voltage output of the TMR IC 110 is at the first level when the actuator is released.

However, as illustrated in FIG. 9B, when the voltage output of the TMR IC 110 is at a second level, for example, low, the current can flow through the TMR IC 110 and the first resistor R1. In particular, when the voltage output of the TMR IC 110 is at the second level, the current can flow through both the first resistor R1 and the second resistor R2. In these embodiments, the voltage output of the TMR IC 110 is at the second level when the actuator is activated.

As best seen in FIG. 8, the PCB 108 can also be connected to an external system, such as a customer system, via a third resistor R3, such as a pull up resistor. As illustrated in FIG. 9C, voltage output to the external system can be a full supply voltage Vcc when a wire between the third resistor R3 and the PCB 108, or a circuit formed by the TMR IC 110, the first resistor R1, and the second resistor R2 thereon, is broken. Conversely, and as illustrated in FIG. 9D, voltage output to the external system can be 0 when the wire between the third resistor R3 and the PCB 108, or a circuit formed by the TMR IC 110, the first resistor R1, and the second resistor R2 thereon, is shorted.

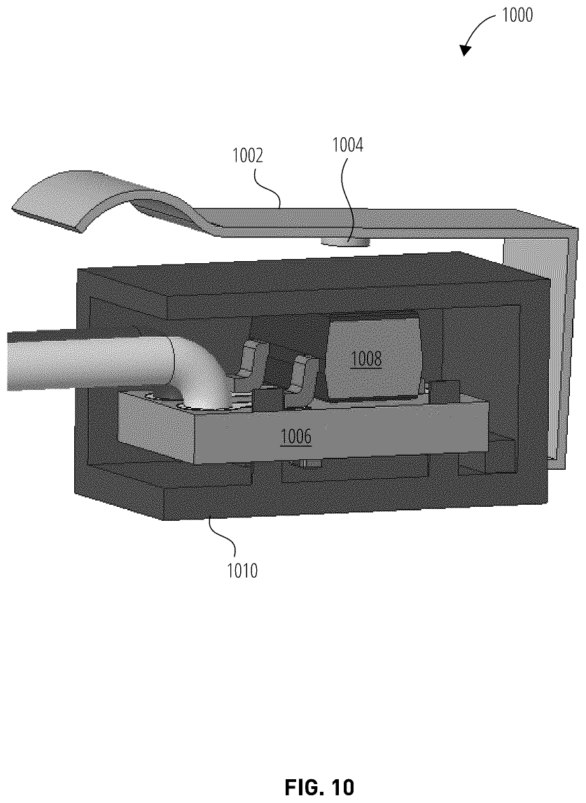

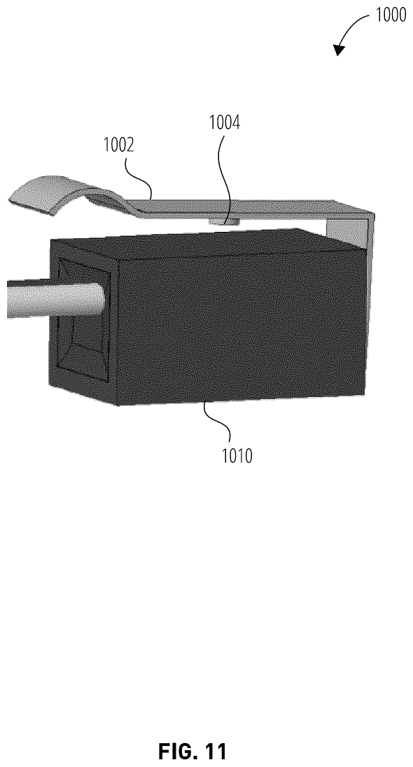

FIG. 10 is an internal view illustrating another positional detection device 1000 in accordance with disclosed embodiments, and FIG. 11 is a perspective view illustrating the positional detection device 1000. As seen, the positional detection device 1000 can include a housing 1010, a switching device, such as a TMR IC 1008, on a PCB 1006 inside of the housing 1010, and a magnet 1004 coupled to an actuator 1002. For example, the magnet 1004 can be disposed on and held, supported, protected, and moved by the actuator 1002. In the embodiments illustrated in FIG. 10 and FIG. 11, the actuator 1002 can include a lever disposed outside of the housing 1010.

Activation of the actuator 1002 can cause a magnetic field to change. For example, when the actuator 1002 is depressed or otherwise moved from a deactivation position to an activation position, that is, towards the housing 1010 and the TMR IC 1008 therein, the magnet 1004 can also move towards the TMR IC 1008, which can cause the magnetic field around the TMR IC 1008 to change. Responsive to the change in the magnetic field, the TMR IC 1008 can allow current flow therethrough as disclosed herein. In this regard, although not specifically illustrated in FIG. 10 and FIG. 11, it is to be understood that the positional detection device 1000 can also include resistors for diagnostic functions as disclosed herein.

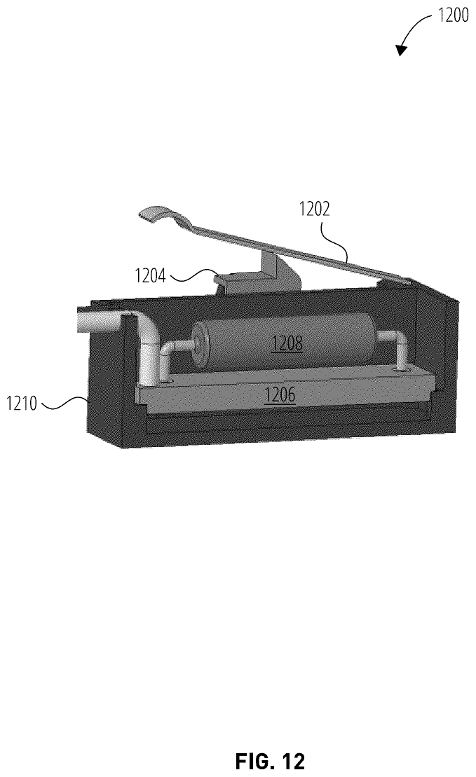

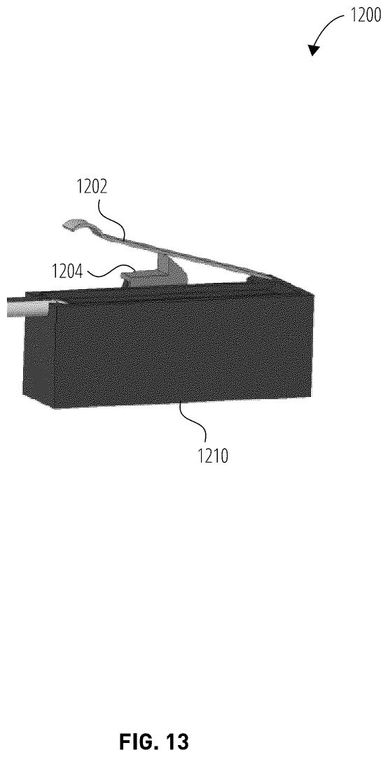

FIG. 12 is an internal view illustrating another positional detection device 1200 in accordance with disclosed embodiments, and FIG. 13 is a perspective view illustrating the positional detection device 1200. As seen, the positional detection device 1200 can include a housing 1210, a switching device, such as a reed switch 1208, on a PCB 1206 inside of the housing 1210, and a magnet 1204 in communication with an actuator 1202. In the embodiments illustrated in FIG. 12 and FIG. 13, the actuator 1202 can include a lever disposed outside of the housing 1210.

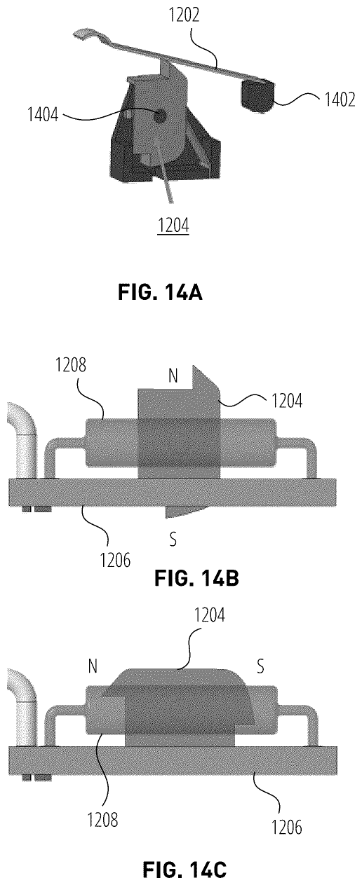

FIG. 14A is a side view illustrating the actuator 1202 and the magnet 1204 in accordance with disclosed embodiments. As seen, the actuator 1202 can include a weight 1402 on a first end thereof to bias the actuator into a deactivation position. A central portion of the actuator 1202 can be in contact with the magnet 1204, which can be mounted on a rotational mount 1404. For example, in some embodiments, the rotational mount 1404 can be part of the housing 1210. In some embodiments, the magnet 1204 can be disposed outside of the housing 1210, and in some embodiments, the magnet 1204 can be disposed inside of the housing 1210, albeit with at least part of the magnet 1204 being accessible for communication with the actuator 1202.

Activation of the actuator 1202 can cause a magnetic field to change. For example, when the actuator 1202 is depressed or otherwise subject to enough force on a second end thereof, opposite the first end, to move from the deactivation position to an activation position, the actuator 1202 can move the magnet 1204 from its own deactivation position to its own activation position, thereby changing a direction the magnetic field of the magnet 1204. In this regard and as seen in FIG. 14B, when the actuator 1202 is weighted by the weight 1402 into the deactivation position, the deactivation position of the magnet 1204 can include north and south poles (N, S) of the magnet 1204 being disposed in a first direction, for example, perpendicular, to a longitudinal direction of the reed switch 1208. However, as seen in FIG. 14C, when the actuator 1202 is moved into the activation position, the magnet 1204 can rotate around the rotational mount 1404 into the activation position, which can include the north and south poles (N, S) of the magnet being disposed in a second direction, for example, parallel, relative to the reed switch 1208.

Changing the direction of the magnetic field of the magnet 1204 can change the magnetic field to which the reed switch 1208 is exposed, responsive to which the reed switch 1208 can allow current to flow therethrough as disclosed herein. In this regard, although not specifically illustrated in FIG. 12, FIG. 13, FIG. 14A, FIG. 14B, and FIG. 14C, it is to be understood that the positional detection device 1200 can also include resistors for diagnostic functions as disclosed herein.

Although the magnet 1204 is shown in FIG. 14A, FIG. 14B, and FIG. 14C as rotating between the deactivation position and the activation position to minimize vertical travel of the actuator 1202, it is to be understood that embodiments disclosed herein are not so limited. Instead, the magnet 1204 could move, traverse, rotate, and/or slide between the deactivation position and the activation position in any manner as would be understood by one of ordinary skill in the art to change the direction of the magnetic field of the magnet 1204.

As used herein, an element or a step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims and equivalents thereof.

What is claimed is:

1. A positional detection device comprising:
a housing;
a tunnel magnetoresistance (TMR) integrated circuit (IC) on a printed circuit board (PCB) inside of the housing;
a pair of magnets disposed on an actuator inside of the housing; and
an activation mechanism disposed outside of the housing and coupled to the actuator,
wherein activation of the activation mechanism causes the actuator to actuate, the pair of magnets to move towards the TMR IC, and a magnetic field around the TMR IC to change, and
wherein, responsive to the change in the magnetic field, the TMR IC allows current flow therethrough.

2. The positional detection device of claim 1 wherein the activation mechanism comprises a rubber dome that provides a spring force and haptics.

3. The positional detection device of claim 1 wherein the TMR IC is centered between the pair of magnets.

4. The positional detection device of claim 1 wherein each of the pair of magnets faces the TMR IC.

5. The positional detection device of claim 4 wherein a respective south pole of each of the pair of magnets faces the TMR IC.

6. The positional detection device of claim 1 wherein the actuator comprises a leaf-style lever.

7. The positional detection device of claim 1 wherein the actuator comprises a wishbone-style lever.

8. The positional detection device of claim 1 further comprising:
at least one resistor on the PCB that enables diagnostic functions.

9. A positional detection device comprising:
a housing;
a tunnel magnetoresistance (TMR) integrated circuit (IC) on a printed circuit board (PCB) inside of the housing;
a magnet disposed on an actuator;
a first resistor coupled to the TMR IC on the PCB; and
a second resistor coupled to the TMR IC on the PCB,
wherein activation of the actuator causes the magnet to move towards the TMR IC and a magnetic field around the TMR IC to change,
wherein, responsive to the change in the magnetic field, a voltage output of the TMR IC changes from high to low,
wherein, when the voltage output of the TMR IC is high, no current flows through the TMR IC or the first resistor, and
wherein, when the voltage output of the TMR IC is low, the current flows through the TMR IC and the first resistor.

10. The positional detection device of claim 9 wherein the first resistor is connected to the TMR IC in series.

11. The positional detection device of claim 9 wherein the second resistor is connected to the TMR IC in parallel.

12. The positional detection device of claim 9 wherein the voltage output of the TMR IC is high when the actuator is released.

13. The positional detection device of claim 12 wherein, when the voltage output of the TMR IC is high, the current flows through the second resistor.

14. The positional detection device of claim 9 wherein the voltage output of the TMR IC is low when the actuator is activated.

15. The positional detection device of claim 14 wherein, when the voltage output of the TMR IC is low, the current flows through the first resistor and the second resistor.

16. The positional detection device of claim 9 wherein the TMR IC, the first resistor, and the second resistor form a circuit, wherein the circuit is connected to an external system via a pull up resistor, and wherein voltage output to the customer system is a full supply voltage when a wire between the circuit and the pull up resistor is broken.

17. The positional detection device of claim 9 wherein the TMR IC, the first resistor, and the second resistor form a circuit, wherein the circuit is connected to an external system via a pull up resistor, and wherein voltage output to the customer system is 0 when a wire between the circuit and the pull up resistor is shorted.

18. A positional detection device comprising:
a housing;
a switching device inside of the housing; and
a magnet coupled to an actuator,
wherein activation of the actuator causes a magnetic field to change, and
wherein responsive to the change in the magnetic field, the switching device allows current flow therethrough.

19. The positional detection device of claim 18 wherein the actuator comprises a lever disposed outside of the housing.

20. The positional detection device of claim 18 further comprising:
at least one resistor on the PCB that enables diagnostic functions.
